(19) United States
(12) Patent Application Publication
(10) Pub. No.: US 2024/0144717 A1
(43) Pub. Date: May 2, 2024

(54) IMAGE ENHANCEMENT FOR IMAGE REGIONS OF INTEREST

(71) Applicant: QUALCOMM Incorporated, San Diego, CA (US)

(72) Inventors: Wen-Chun FENG, New Taipei City (TW); Kai LIU, Taipei (TW); Su-Chin CHIU, Wanhua Dist. (TW); Chung-Yan CHIH, Xinyi Dist. (TW); Yu-Ren LAI, Xinyi Dist. (TW)

(21) Appl. No.: 18/049,897

(22) Filed: Oct. 26, 2022

(51) Int. Cl. G06V 40/16; G06T 3/40; G06V 10/24; G06V 10/25

(52) U.S. Cl. CPC G06V 40/165; G06T 3/40; G06V 10/245; G06V 10/25; G06V 40/166

(57) ABSTRACT

Disclosed are systems, apparatuses, processes, and computer-readable media to capture images. A method of processing image data includes determining a first region of interest (ROI) in an image. The first ROI is associated with a first object. The method can include determining one or more image characteristics of the first ROI. The method can further include determining whether to perform an upsampling process on image data in the first ROI based on the one or more image characteristics of the first ROI.

### FIELD

The present application is generally related to processing image data. For example, aspects of the present disclosure relate to systems and techniques for selectively enhancing regions of images based on characteristics of the regions.

### BACKGROUND

A camera is a device that receives light and captures image frames, such as still images or video frames, using an image sensor. Cameras may include processors, such as image signal processors (ISPs), that can receive one or more image frames and process the one or more image frames. For example, a raw image frame captured by a camera sensor can be processed by an ISP to generate a final image. Cameras can be configured with a variety of image capture and image processing settings to alter the appearance of an image. The application of different settings can result in frames or images with different appearances.

### SUMMARY

In some examples, systems and techniques are described for selectively enhancing one or more regions of interest in images (e.g., corresponding to one or objects, such as a person, a face, a vehicle, etc.) based on characteristics of image data in the region(s) of interest. The systems and techniques can improve image quality objects of interest in a captured image.

According to at least one example, a method is provided for processing one or more images. The method includes: determining a first region of interest (ROI) in an image, wherein the first ROI is associated with a first object; determining one or more image characteristics of the first ROI; and determining whether to perform an upsampling process on image data in the first ROI based on the one or more image characteristics of the first ROI.

In another example, an apparatus for processing one or more images is provided that includes at least one memory and at least one processor coupled to the at least one memory. The at least one processor is configured to: determine a first ROI in an image, wherein the first ROI is associated with a first object; determine one or more image characteristics of the first ROI; and determine whether to perform an upsampling process on image data in the first ROI based on the one or more image characteristics of the first ROI.

In another example, a non-transitory computer-readable medium is provided that has stored thereon instructions that, when executed by one or more processors, cause the one or more processors to: determine a first ROI in an image, wherein the first ROI is associated with a first object; determine one or more image characteristics of the first ROI; and determine whether to perform an upsampling process on image data in the first ROI based on the one or more image characteristics of the first ROI.

In another example, an apparatus for processing one or more images is provided. The apparatus includes: means for determining a first ROI in an image, wherein the first ROI is associated with a first object; means for determining one or more image characteristics of the first ROI; and means for determining whether to perform an upsampling process on image data in the first ROI based on the one or more image characteristics of the first ROI.

In some aspects, the apparatus is, is part of, and/or includes a mobile device (e.g., a mobile telephone and/or mobile handset and/or so-called “smart phone” or other mobile device), an extended reality (XR) device (e.g., a virtual reality (VR) device, an augmented reality (AR) device, or a mixed reality (MR) device), a head-mounted device (HMD) device, a vehicle or a computing device or component of a vehicle, a wearable device (e.g., a network-connected watch or other wearable device), a wireless communication device, a camera, a personal computer, a laptop computer, a server computer, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1A, FIG. 1B, and FIG. 1C are diagrams illustrating example configurations for an image sensor of an image capture device, in accordance with aspects of the present disclosure.

FIG. 2 is a block diagram illustrating an architecture of an image capture and processing device, in accordance with aspects of the present disclosure.

FIG. 3 is a block diagram illustrating an example of an image capture system, in accordance with aspects of the present disclosure.

FIG. 4 illustrates a block diagram of an image processing device 400 that uses a super resolution technique to enhance at least a portion of an image, in accordance with aspects of the present disclosure.

FIG. 5A illustrates an example of an image obtained by an image processing device in accordance with some aspects of the disclosure.

FIG. 5B illustrates an upsampled version of the region of interest 502 illustrated in FIG. 5A.

FIG. 5C illustrates an upsampled version of the region of interest 502 illustrated in FIG. 5A modified based on super resolution techniques in accordance with some aspects of the disclosure.

FIG. 6A illustrates an example of a region of interest 602 that is detected by an image processing device.

FIG. 6B illustrates example keypoints that can be detected by a ROI preprocessor to determine a transformation to apply to the ROI in accordance with some aspects of the disclosure.

FIG. 6C illustrates an example transformation applied to the region of interest 602.

FIG. 7A illustrates a result of an image synthesis after post-processing by the ROI post-processor in accordance with some aspects of the disclosure.

FIG. 7B illustrates a result of an image synthesis after post-processing by the ROI post-processor after adjusting the ROI in accordance with some aspects of the disclosure.

FIG. 8 illustrates an example of an image that an ROI analyzer that can identify at least one ROI that may cause the ROI analyzer to control an image sensor in accordance with some aspects of the disclosure.

FIG. 9 illustrates an example of a trigger module 900 that is configured to enable or disable a SR function in accordance with some aspects of the disclosure.

FIG. 10 is a flowchart illustrating another example of a method for performing super resolution functions, in accordance with aspects of the present disclosure.

FIG. 11 illustrates an example diagram implementing a generative adversarial network (GAN) to perform super resolution (SR) functions in accordance with certain aspects of the present disclosure.

FIG. 12 illustrates an example generator portion of a GAN in accordance with certain aspects of the present disclosure.

FIG. 13 illustrates an example discriminator portion of a GAN in accordance with certain aspects of the present disclosure.

FIG. 14 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The ensuing description provides example aspects only, and is not intended to limit the scope, applicability, or configuration of the disclosure. Rather, the ensuing description of the exemplary aspects will provide those skilled in the art with an enabling description for implementing an aspect of the disclosure. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during the capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor (ISP)) for processing the one or more image frames captured by the image sensor.

Digital image upscale operations may sometimes be referred to as super resolution (SR) operations. For example, using a super resolution operation, a 4k (3840 by 2160 pixels) resolution display output may be scaled up from a 1080p (1920 by 1080 pixels) resolution input. Such super resolution operations may apply to different resolutions depending on specific applications (e.g., from 4k to 7680 by 4320 pixels). There are different algorithms that can be performed to upscale images to higher resolutions, each achieving different levels of restoration (e.g., if compressed or scaled-down previously), realism (e.g., if artificially generated), and/or accuracy (e.g., if a scene of reality is available for comparison).

Machine learning, such as employing deep learning neural networks, can often achieve better results in terms of restoration, realism, or accuracy than pre-defined algorithms (e.g., bicubic). In some instances, part of the deep learning networks generates one or more scaled-up versions of the input, and another part compares and rates the scaled-up versions to a set of reference images to identify a way of processing (e.g., learning one or more parameters) resulting in a desired output. The way of processing is thus “learned” by the super resolution networks instead of being pre-programmed.

In some cases, a captured image may be limited based on a resolution of the image and based on different portions of the image being in or out of focus. By way of example, a user of the device may want to enhance an image that includes a plurality of regions of interest (ROIs), for example corresponding to a group of faces, so that a resulting image more clearly identifies at least one face of a person from the group of faces. This scenario can include numerous issues such as the ROI associated with the person's face having a small size that is relative to the entire image. In other cases, the face of the person can be out of focus based on a depth of field (DOF) associated with the camera setting. In these cases, SR functions cannot be applied to the image.

In some aspects, systems, apparatuses, processes (also referred to as methods), and computer-readable media (collectively referred to herein as “systems and techniques”) are described for identifying and improving an image including at least one ROI. For instance, the systems and techniques can determine or identify an ROI and determine whether to perform an upsampling process (e.g., a SR technique) in the event a person is located within the ROI. For example, based on determining the ROI, the systems and techniques can determine one or more image characteristics of the ROI. One illustrative example of an image characteristic is a size of the ROI (or a size of the ROI relative to the entire image). For instance, the ROI can be less than a size threshold that is suitable for the SR process. In some cases, the size threshold can be any suitable size, such as 100 pixels (px)×100px, 50px×50px, or other suitable size. Another illustrative example of an image characteristic is a sharpness of the image, which can be measured based on a signal-to-noise (SNR) ratio. Another example of an image characteristic is a distance of the first ROI from a focal point relative to a threshold distance.

After detecting the one or more image characteristics of the ROI, the systems and techniques can determine whether to perform an upsampling process (e.g., a SR technique) on image data in the ROI based on the one or more image characteristics of the ROI. For instance, the systems and techniques can perform the upsampling process if a size of the ROI is less than the size threshold, if the sharpness of the image data in the ROI is less than a sharpness threshold, if the distance of the first ROI from the focal point is greater than the threshold distance, and/or based on other characteristics of the ROI.

In some aspects, images that are of limited quality and within a range can be preprocessed before an upsampling process. For example, in the event that the subject identified in the image is rotated based on position of the person (e.g., leaning) or the position of the camera (e.g., rotated so that a subject is slightly rotated), the systems and techniques can preprocess the ROI to align the subject to improve image enhancement operations. Further aspects of the systems and techniques include enabling the upsampling process based on gaze detection, device orientation, facial recognition, and other factors.

Additional details and aspects of the present disclosure are described in more detail below with respect to the figures.

Image sensors include one or more arrays of photodiodes or other photosensitive elements. Each photodiode measures an amount of light that eventually corresponds to a particular pixel in the image produced by the image sensor. In some cases, different photodiodes may be covered by different color filters of a color filter array and may thus measure light matching the color of the color filter covering the photodiode.

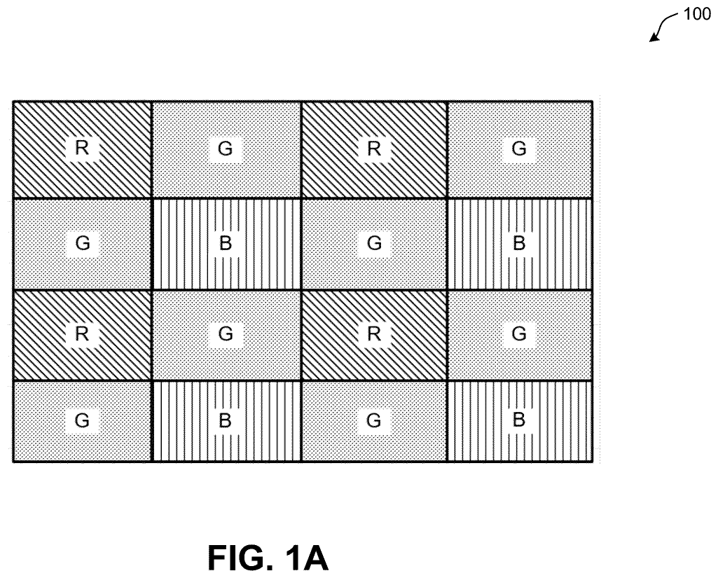

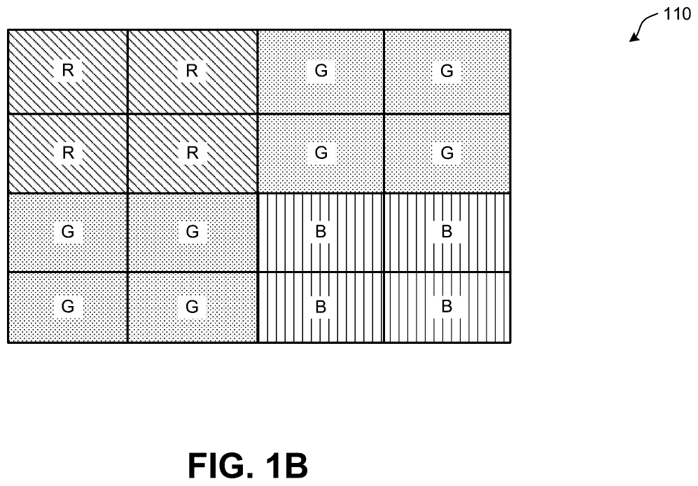

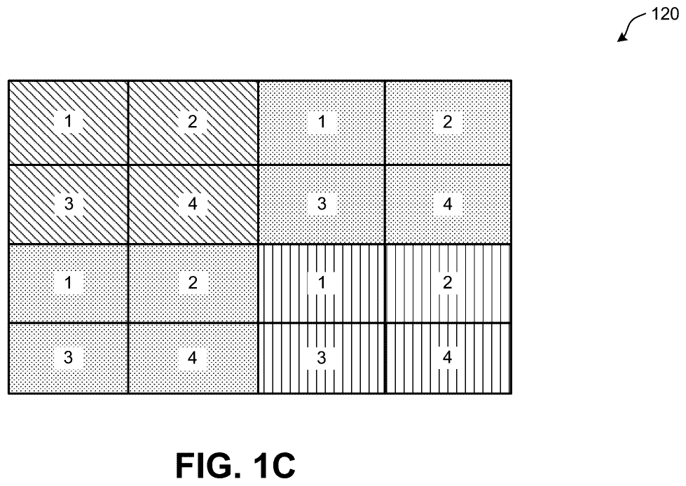

Various color filter arrays can be used, including a Bayer color filter array, a quad color filter array (also referred to as a quad Bayer filter or QCFA), and/or other color filter array. An example of a Bayer color filter array 100 is shown in FIG. 1A. As shown, the Bayer color filter array 100 includes a repeating pattern of red color filters, blue color filters, and green color filters. As shown in FIG. 1B, a QCFA 110 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the QCFA 110 shown in FIG. 1B is repeated for the entire array of photodiodes of a given image sensor. Using either QCFA 110 or the Bayer color filter array 100, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. The different photodiodes throughout the pixel array can have different spectral sensitivity curves, therefore responding to different wavelengths of light. Monochrome image sensors may also lack color filters and therefore lack color depth.

In some cases, subgroups of multiple adjacent photodiodes (e.g., 2×2 patches of photodiodes when QCFA 110 shown in FIG. 1B is used) can measure the same color of light for approximately the same region of a scene. For example, when photodiodes included in each of the subgroups of photodiodes are in close physical proximity, the light incident on each photodiode of a subgroup can originate from approximately the same location in a scene (e.g., a portion of a leaf on a tree, a small section of sky, etc.).

In some examples, a brightness range of light from a scene may significantly exceed the brightness levels that the image sensor can capture. For example, a digital single-lens reflex (DSLR) camera may be able to capture a 1:30,000 contrast ratio of light from a scene while the brightness levels of an HDR scene can exceed a 1:1,000,000 contrast ratio.

In some cases, HDR sensors may be utilized to enhance the contrast ratio of an image captured by an image capture device. In some examples, HDR sensors may be used to obtain multiple exposures within one image or frame, where such multiple exposures can include short (e.g., 5 ms) and long (e.g., 15 or more ms) exposure times. As used herein, a long-exposure time generally refers to any exposure time that longer than a short-exposure time.

In some implementations, HDR sensors may be able to configure individual photodiodes within subgroups of photodiodes (e.g., the four individual R photodiodes, the four individual B photodiodes, and the four individual G photodiodes from each of the two 2×2 G patches in the QCFA 110 shown in FIG. 1B) to have different exposure settings. A collection of photodiodes with matching exposure settings is also referred to as photodiode exposure group herein. FIG. 1C illustrates a portion of an image sensor array with a QCFA filter that is configured with four different photodiode exposure groups 1 through 4. As shown in the example photodiode exposure group array 120 in FIG. 1C, each 2×2 patch can include a photodiode from each of the different photodiode exposure groups for a particular image sensor. Although four groupings are shown in a specific grouping in FIG. 1C, a person of ordinary skill will recognize that different numbers of photodiode exposure groups, different arrangements of photodiode exposure groups within subgroups, and any combination thereof can be used without departing from the scope of the present disclosure.

As noted with respect to FIG. 1C, in some HDR image sensor implementations, exposure settings corresponding to different photodiode exposure groups can include different exposure times (also referred to as exposure lengths), such as short exposure, medium exposure, and long exposure. In some cases, different images of a scene associated with different exposure settings can be formed from the light captured by the photodiodes of each photodiode exposure group. For example, a first image can be formed from the light captured by photodiodes of photodiode exposure group 1, a second image can be formed from the photodiodes of photodiode exposure group 2, a third image can be formed from the light captured by photodiodes of photodiode exposure group 3, and a fourth image can be formed from the light captured by photodiodes of photodiode exposure group 4. Based on the differences in the exposure settings corresponding to each group, the brightness of objects in the scene captured by the image sensor can differ in each image. For example, well-illuminated objects captured by a photodiode with a long-exposure setting may appear saturated (e.g., completely white). In some cases, an image processor can select between pixels of the images corresponding to different exposure settings to form a combined image.

In one illustrative example, the first image corresponds to a short-exposure time (also referred to as a short-exposure image), the second image corresponds to a medium exposure time (also referred to as a medium exposure image), and the third and fourth images correspond to a long-exposure time (also referred to as long-exposure images). In such an example, pixels of the combined image corresponding to portions of a scene that have low illumination (e.g., portions of a scene that are in a shadow) can be selected from a long-exposure image (e.g., the third image or the fourth image). Similarly, pixels of the combined image corresponding to portions of a scene that have high illumination (e.g., portions of a scene that are in direct sunlight) can be selected from a short-exposure image (e.g., the first image.

In some cases, an image sensor can also utilize photodiode exposure groups to capture objects in motion without blur. The length of the exposure time of a photodiode group can correspond to the distance that an object in a scene moves during the exposure time. If light from an object in motion is captured by photodiodes corresponding to multiple image pixels during the exposure time, the object in motion can appear to blur across the multiple image pixels (also referred to as motion blur). In some implementations, motion blur can be reduced by configuring one or more photodiode groups with short-exposure times. In some implementations, an image capture device (e.g., a camera) can determine local amounts of motion (e.g., motion gradients) within a scene by comparing the locations of objects between two consecutively captured images. For example, motion can be detected in preview images captured by the image capture device to provide a preview function to a user on a display. In some cases, a machine learning model can be trained to detect localized motion between consecutive images.

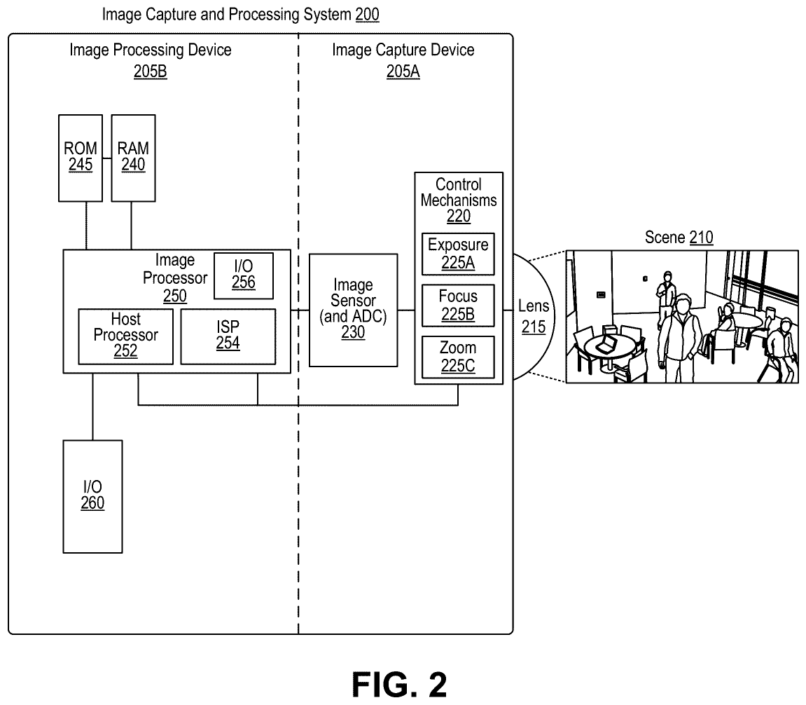

Various aspects of the techniques described herein will be discussed below with respect to the figures. FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. In some cases, the lens 215 and image sensor 230 can be associated with an optical axis. In one illustrative example, the photosensitive area of the image sensor 230 (e.g., the photodiodes) and the lens 215 can both be centered on the optical axis. A lens 215 of the image capture and processing system 200 faces a scene 210 and receives light from the scene 210. The lens 215 bends incoming light from the scene toward the image sensor 230. The light received by the lens 215 passes through an aperture. In some cases, the aperture (e.g., the aperture size) is controlled by one or more control mechanisms 220 and is received by an image sensor 230. In some cases, the aperture can have a fixed size.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo (or other lens mechanism), thereby adjusting focus. In some cases, additional lenses may be included in the image capture and processing system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 220, the image sensor 230, and/or the image processor 250. The focus setting may be referred to as an image capture setting and/or an image processing setting. In some cases, the lens 215 can be fixed relative to the image sensor and focus control mechanism 225B can be omitted without departing from the scope of the present disclosure.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 225C moves one or more of the lenses in the afocal zoom system, such as the negative lens and one or both of the positive lenses. In some cases, zoom control mechanism 225C can control the zoom by capturing an image from an image sensor of a plurality of image sensors (e.g., including image sensor 230) with a zoom corresponding to the zoom setting. For example, image processing system 200 can include a wide angle image sensor with a relatively low zoom and a telephoto image sensor with a greater zoom. In some cases, based on the selected zoom setting, the zoom control mechanism 225C can capture images from a corresponding sensor.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different filters. In some cases, different photodiodes can be covered in color filters, and may thus measure light matching the color of the filter covering the photodiode. Various color filter arrays can be used, including a Bayer color filter array (as shown in FIG. 1A), a QCFA (see FIG. 1B), and/or any other color filter array.

Returning to FIG. 1A and FIG. 1B, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 230) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 230 may alternately or additionally include opaque and/or reflective masks that block light from reaching certain photodiodes, or portions of certain photodiodes, at certain times and/or from certain angles. In some cases, opaque and/or reflective masks may be used for PDAF. In some cases, the opaque and/or reflective masks may be used to block portions of the electromagnetic spectrum from reaching the photodiodes of the image sensor (e.g., an IR cut filter, an ultraviolet (UV) cut filter, a band-pass filter, low-pass filter, high-pass filter, or the like). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

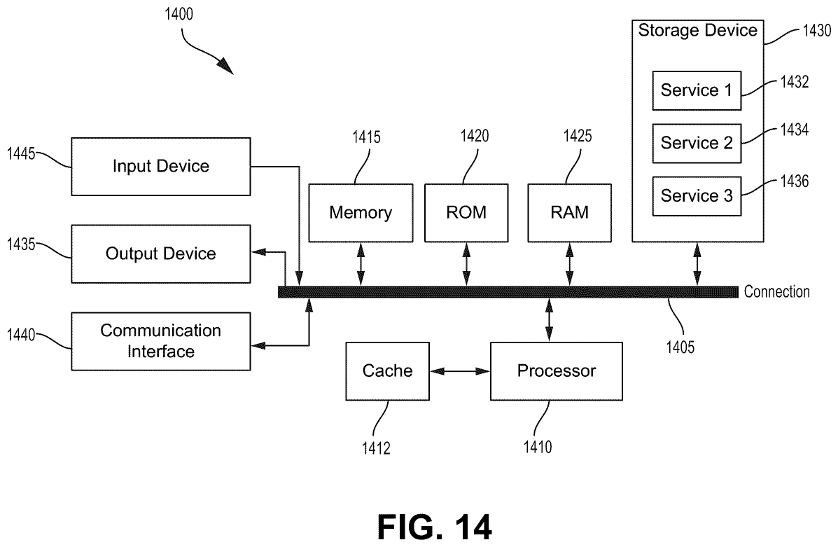

The image processor 250 may include one or more processors, such as one or more ISPs (e.g., ISP 254), one or more host processors (e.g., host processor 252), and/or one or more of any other type of processor 1410 discussed with respect to the computing system 1400 of FIG. 14. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using a MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 240, read-only memory (ROM) 245, a cache, a memory unit, another storage device, or some combination thereof.

Various input/output (I/O) devices 260 may be connected to the image processor 250. The I/O devices 260 can include a display screen, a keyboard, a keypad, a touchscreen, a trackpad, a touch-sensitive surface, a printer, any other output devices (e.g., output device 1435 of FIG. 14), any other input devices (e.g., input device 1445 of FIG. 14), or some combination thereof. In some cases, a caption may be input into the image processing device 205B through a physical keyboard or keypad of the I/O devices 260, or through a virtual keyboard or keypad of a touchscreen of the I/O devices 260. The I/O 260 may include one or more ports, jacks, or other connectors that enable a wired connection between the image capture and processing system 200 and one or more peripheral devices, over which the image capture and processing system 200 may receive data from the one or more peripheral device and/or transmit data to the one or more peripheral devices. The I/O 260 may include one or more wireless transceivers that enable a wireless connection between the image capture and processing system 200 and one or more peripheral devices, over which the image capture and processing system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

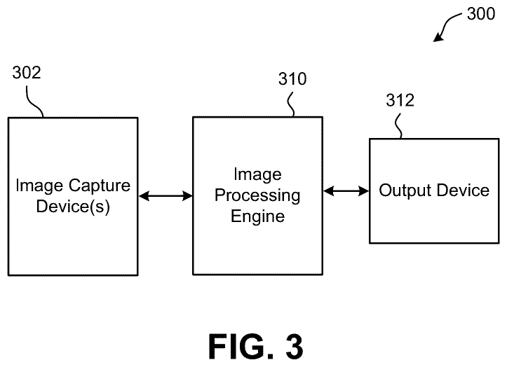

FIG. 3 is a block diagram illustrating an example of an image capture system 300. The image capture system 300 includes various components that are used to process input images or frames to produce an output image or frame. As shown, the components of the image capture system 300 include one or more image capture devices 302, an image processing engine 310, and an output device 312. The image processing engine 310 can produce high dynamic range depictions of a scene, as described in more detail herein.

The image capture system 300 can include or be part of an electronic device or system. For example, the image capture system 300 can include or be part of an electronic device or system, such as a mobile or stationary telephone handset (e.g., smartphone, cellular telephone, or the like), an extended reality (XR) device (e.g., a virtual reality (VR) device, an augmented reality (AR) device, or a mixed reality (MR) device), a vehicle or computing device/system of a vehicle, a server computer (e.g., in communication with another device or system, such as a mobile device, an XR system/device, a vehicle computing system/device, etc.), a desktop computer, a laptop or notebook computer, a tablet computer, a set-top box, a television, a camera device, a display device, a digital media player, a video streaming device, or any other suitable electronic device. In some examples, the image capture system 300 can include one or more wireless transceivers (or separate wireless receivers and transmitters) for wireless communications, such as cellular network communications, 802.11 Wi-Fi communications, WLAN communications, Bluetooth or other short-range communications, any combination thereof, and/or other communications. In some implementations, the components of the image capture system 300 can be part of the same computing device. In some implementations, the components of the image capture system 300 can be part of two or more separate computing devices.

While the image capture system 300 is shown to include certain components, one of ordinary skill will appreciate that image capture system 300 can include more components or fewer components than those shown in FIG. 3. In some cases, additional components of the image capture system 300 can include software, hardware, or one or more combinations of software and hardware. For example, in some cases, the image capture system 300 can include one or more other sensors (e.g., one or more inertial measurement units (IMUs), radars, light detection and ranging (LIDAR) sensors, audio sensors, etc.), one or more display devices, one or more other processing engines, one or more other hardware components, and/or one or more other software and/or hardware components that are not shown in FIG. 3. In some implementations, additional components of the image capture system 300 can include and/or can be implemented using electronic circuits or other electronic hardware, which can include one or more programmable electronic circuits (e.g., DSPs, microprocessors, microcontrollers, GPUs, CPUs, any combination thereof, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture system 300.

The one or more image capture devices 302 can capture image data and generate images (or frames) based on the image data and/or can provide the image data to the image processing engine 310 for further processing. The one or more image capture devices 302 can also provide the image data to the output device 312 for output (e.g., on a display). In some cases, the output device 312 can also include storage. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image. In addition to image data, the image capture devices can also generate supplemental information such as the amount of time between successively captured images, timestamps of image capture, or the like.

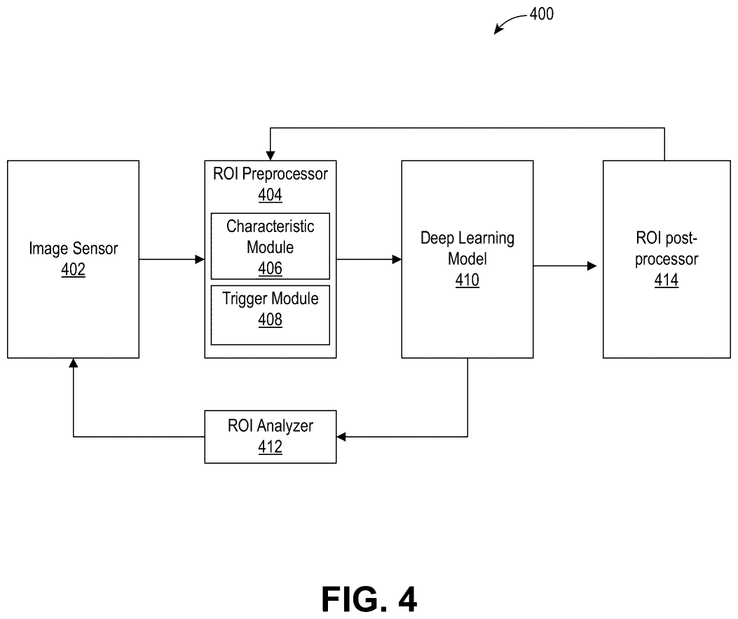

FIG. 4 illustrates a block diagram of an image processing device 400 that uses an upsampling process to enhance at least a portion of an image. One illustrative example of an upsampling process is a super resolution (SR) process. The image processing device 400 includes an image sensor 402 (e.g., image processor 250) configured to capture images by exposing light to a sensor array. The image sensor 402 is configured to provide a captured image to a region of interest (ROI) preprocessor 404. The ROI preprocessor 404 is configured to identify various ROIs using various techniques. An illustrative example of a ROI is an object of interest in the image such as a face. Other examples of a ROI include a one of a face region of a person, a stationary object (e.g., a landmark such as a sculpture, a building, etc.), an animated object (e.g., a moving vehicle), vegetation, a natural geographic formation, and an animal. In some examples, the ROI preprocessor 404 may be configured to detect a plurality of ROIs, such as different objects in the scene including faces, animals, landmarks, and so forth.

In some aspects, the ROI preprocessor 404 can include a characteristic detection module 406 that is configured to identify ROIs that can be enhanced using an upsampling process (e.g., an SR process). An example of an ROI identified for an upsampling process includes a region that is smaller than a size threshold (e.g., a resolution of 100×100 pixels). Another example of a region for an upsampling process includes a region having a sharpness within a particular range or less than a sharpness threshold. For example, an object within a captured image can be slightly defocused based on a distance from the image sensor to the object and the focal length. For example, a focal length includes a depth of field (DOF) and objects at the very edge of the DOF or outside of the DOF may appear blurred. A sharpness can be determined for the region to determine whether the an upsampling process can be applied to the image. In some aspects, at least two characteristics of the characteristic detection module 406 can be combined to determine whether an upsampling process can be implemented to improve the quality of the images.

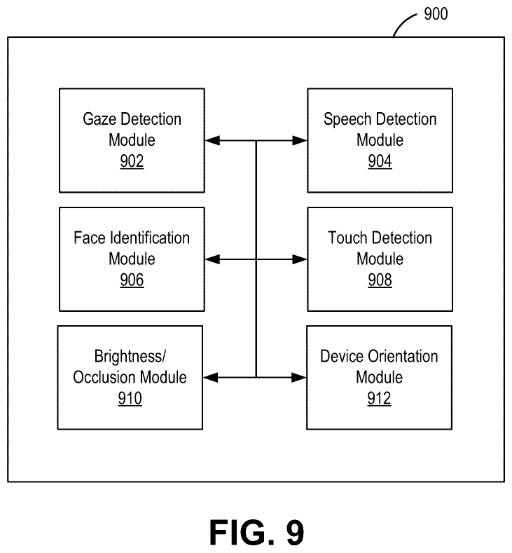

The ROI preprocessor 404 can include a trigger module 408 that can selectively enable an upsampling process (e.g., a SR process) based on various aspects. Illustrative examples of triggers include gaze detection, speech detection, face identification, touch detection, device orientation detection, and brightness/occlusion detection. For example, the ROI preprocessor 404 can be triggered by gaze detection, or when a face in an image is determined to be looking at the image sensor 402. As a result of detecting a face that is directing the gaze at the image sensor 402, the ROI preprocessor 404 can determine that the face is an ROI and can be enhanced using a super resolution function. Various examples of triggers are further described herein with reference to FIG. 9.

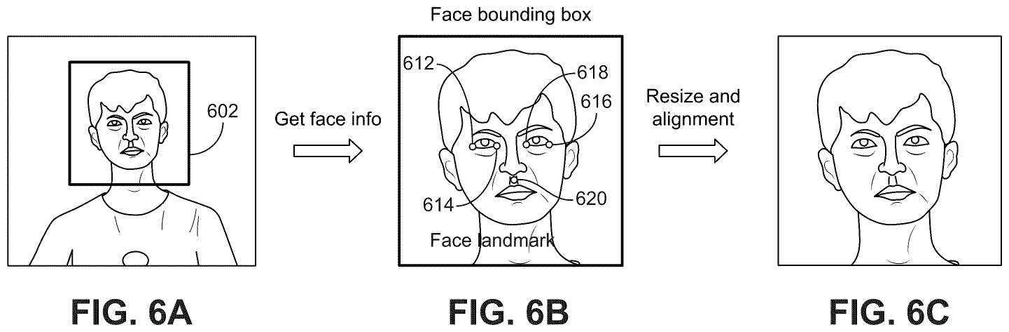

Further aspects of the ROI preprocessor 404 include additional processing steps to provide various corrections to improve the SR techniques. In one illustrative aspect, the ROI preprocessor 404 can extract a portion of an image that corresponds to the ROI and perform various corrections to improve SR systems and techniques that may be applied to the ROI. As further illustrated in FIG. 6B, the ROI preprocessor 404 can identify keypoints of various features within the ROI and transform the ROI (e.g., the portion of the image) to align a portion of the keypoints. As an example, the keypoints can correspond to the edges of a person's eyes and may be rotated slightly while obtaining the image. In such a case, the ROI preprocessor 404 may rotate the ROI (e.g., the portion of the image) to vertically align the keypoints associated with the person's eyes. In other aspects, other types of transformations could be applied, such as a three-dimensional skewing, or correction due to distortion created by the lens at peripheral edges.

At least one preprocessed ROI (e.g., a rotated portion of the image that is deemed blurry based on a calculation) can be provided to a deep learning model 410 that is configured to improve the image quality of the at least one preprocessed ROI. In some aspects, the deep learning model 410 can be a neural network that is configured to improve the image quality using various techniques. An illustrative deep learning model 410 can be a convolutional neural network (CNN), which is designed to adaptively learn spatial hierarchies of features through backpropagation by using multiple building blocks, such as convolution layers, pooling layers, and fully connected layers. In some cases, a CNN can be used to improve an image. Another illustrative deep learning model 410 is a generative adversarial network (GAN). A GAN can be configured to infer content and then apply the inferred content onto the original content to improve the quality of the original content.

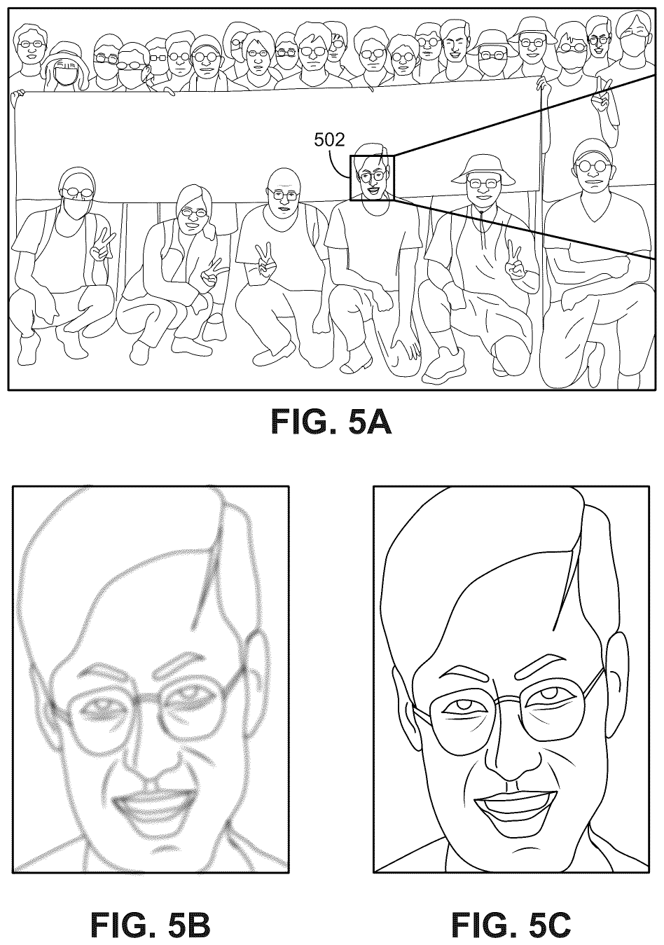

In some aspects, the deep learning model 410 can configured to perform a SR function and create upsampled versions of the at least one preprocessed ROI that have a higher resolution (e.g., 400px×400px) than the original ROI (e.g., 100px×100px) and with the enhancement that is applied to fill in additional detail. In one illustrative example, a GAN can be configured to create content based on a training set, such as a collection of images of faces, and learn how to infer details within an upsampled version of the original image. Examples of a SR function are illustrated with reference to FIG. 5B and FIG. 5C. The deep learning model 410 can output an enhanced ROI for each ROI in the at least one preprocessed ROI to an ROI analyzer 412 and a postprocessor 414.

Various aspects of the disclosure include an ROI analyzer 412 configured to analyze the enhanced ROI to improve image capture of the image processing device 400. In one illustrative aspect, the image processing device 400 may be configured to capture images or video and the ROI analyzer 412 can identify that at least one ROI from a plurality of ROIs has a characteristic indicative of a lower quality. An example of characteristic indicative of lower quality includes a sharpness factor. In this case, the ROI analyzer 412 can control the image sensor 402 to shift the focus of a lens module (not shown) to improve the sharpness of the at least one ROI. For example, if there are four ROIs in the image and a background ROI is out of focus based on being outside of the DOF, the ROI analyzer 412 may be configured to shift the focal point between an intermediate point between foreground ROIs that have a high sharpness and the background ROI to improve the sharpness of the background ROI. In this case, the sharpness of the foreground ROIs may diminish an insignificant amount while increasing the sharpness of the background ROIs. The image sensor 402 thereby can capture a subsequent image and apply the deep learning model 410 to the subsequent image to improve image quality. In particular, the SR function applied to the background ROI will have a greater effect.

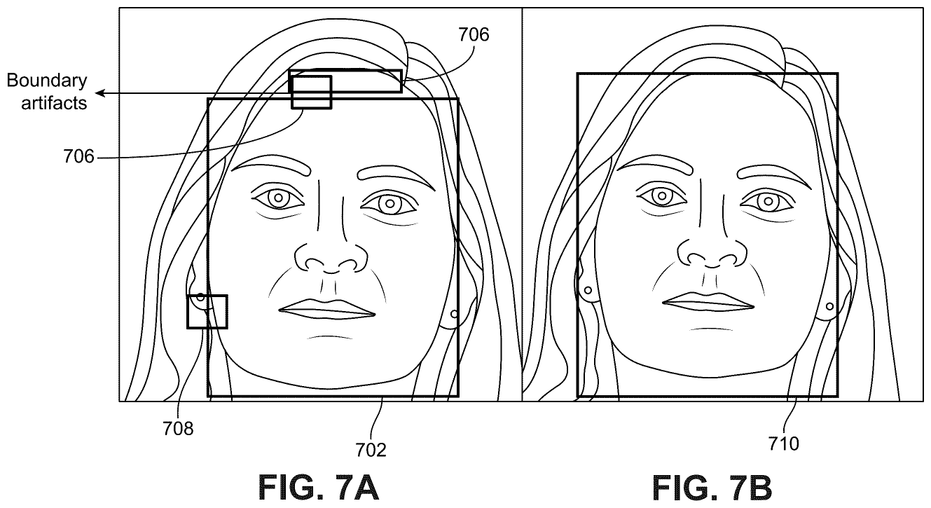

The at least one enhanced ROI is also provided to the postprocessor 414 for merging the at least one enhanced ROI into the original image or an upsampled version of the original image. For example, a bicubic interpolation can be applied to the original image to yield an upsampled image, and the at least one enhanced ROI can be inserted or blended into the upsampled image. In another aspect of the postprocessor 414, the postprocessor 414 may be configured to inverse the transformation applied by the ROI preprocessor 404, such as rotating the at least one enhanced ROI. In yet another aspect of the postprocessor 414, the postprocessor 414 may control a bounding region associated with the ROI preprocessor 404 when inserting or blending the at least one enhanced ROI into the upsampled image. Examples of controlling a bounding region are further illustrated with reference to FIGS. 7A and 7B.

FIG. 5A illustrates an example of an image obtained by an image processing device in accordance with some aspects of the disclosure. In one illustrative example, a person located within the image may want to enlarge the image for various purposes, such as for use as a headshot in various profiles. In this case, a bounding region that identifies a region of interest 502 that corresponds to the person's face and may have a resolution less than a threshold (e.g., 100×100). Due to the lower resolution of the person's face, the image may have less utility and the person may desire an enhanced version of the image by upscaling the image.

FIG. 5B illustrates an upsampled version of the region of interest 502 illustrated in FIG. 5A. In particular, FIG. 5B illustrates a conventional bicubic interpolation to upsample the region of interest 502 and blurs the subject as a result of conventional techniques. In a bicubic interpolation, the image is enhanced based on internal data only and the results in the blurred result.

FIG. 5C illustrates an upsampled version of the ROI 502 illustrated in FIG. 5A uses super resolution techniques in accordance with some aspects of the disclosure. For example, the region of interest may be identified and enhanced using the image processing device 400, which adds content into in the ROI 502 to create a sharper image. For example, the ROI 502 can be input into the deep learning model (e.g., the deep learning model 410), which infers content based on the learning performed during the training, and creates the shaper image in FIG. 5C. In this case, the image in FIG. 5C may have more utility.

FIG. 6A illustrates an example of a region of interest 602 that is detected by an image processing device. In this case, the subject in the region of interest 602 is not aligned due to various factors, such as the image processing device is slightly rotated. FIG. 6B illustrates example keypoints that can be detected by a ROI preprocessor to determine a transformation to apply to the ROI in accordance with some aspects of the disclosure. In this case, the preprocessor can include a model for detecting various features, such as keypoints associated with the person's face. Non-limiting examples of keypoints detected by a preprocessor include an outer corner of the right eye 612, an inner corner of the right eye 614, an outer corner of the left eye 616, an inner corner of the left eye 618, and a nasal edge 620. In some aspects, the preprocessor can identify an alignment issue, such as an angle of rotation based on the various keypoints

FIG. 6C illustrates an example transformation applied to the region of interest 602. In this case, the ROI is rotated to align the keypoints associated with the right eye 612, an inner corner of the right eye 614, an outer corner of the left eye 616, and an inner corner of the left eye 618. As noted above, the aligning the ROI can increase the effectiveness of the deep learning model.

FIG. 7A illustrates a result of an image synthesis after post-processing by the ROI post-processor in accordance with some aspects of the disclosure. In this case, the bounding region 702 associated with the ROI is upscaled and enhanced by a deep learning model and is blended back into an upscaled version (e.g. bicubic scaling) of the original image. The bounding region 702 omits a first portion 704 and a second portion 706 of the person's face and the blending creates a noisy region 708 around the peripheral region of the bounding region 702. As a result of the noisy region 708, increases artifacts that decrease the image quality of the upscaled image.

In some aspects, the ROI post-processor may be configured to perform an iterative check to identify noisy regions based on an analysis of the peripheral regions associated with the skin region. For example, the ROI post-processor can analyze a region at the peripheral regions to determine if the region corresponds to the skin region based on color (e.g., by looking at color profiles, etc.). If the ROI post-processor identifies a skin region at the peripheral region, the ROI post-processor may then determine if the region outside of the ROI but adjacent to the peripheral region also corresponds to a skin region. In the event that the ROI post-processor identifies a skin region in the ROI and a skin region outside of the ROI, the ROI post-processor may then feedback information to the preprocessor to modify the ROI.

FIG. 7B illustrates a result of an image synthesis after post-processing by the ROI post-processor after adjusting the ROI in accordance with some aspects of the disclosure. In this case, a bounding region 710 is modified to include the first portion 704 and second portion 706 and the blending of the image omits the noisy region 708.

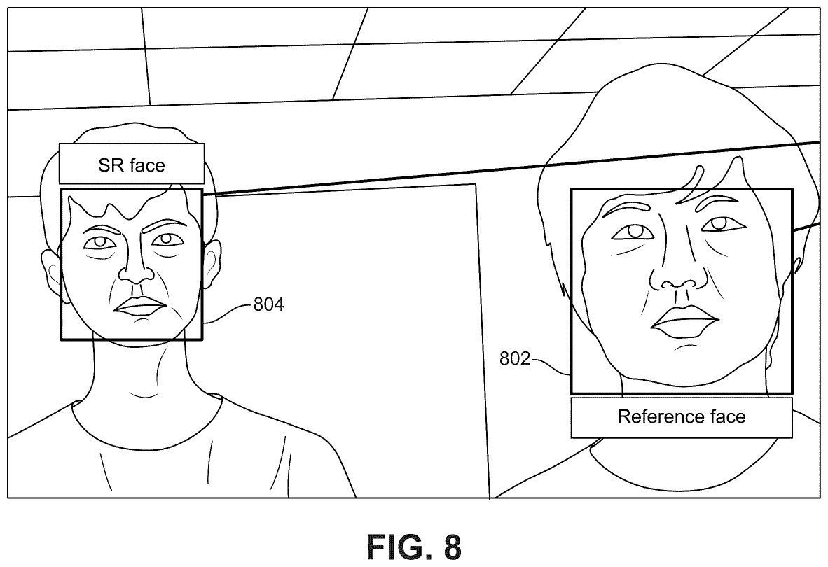

FIG. 8 illustrates an example of an image that an ROI analyzer can identify at least one ROI that may cause the ROI analyzer to control an image sensor in accordance with some aspects of the disclosure. As described above, the ROI analyzer is configured to analyze each ROI and control the image processing system based on the ROI. By way of example, a first ROI 802 is located proximate to the image sensor that obtains the image with a large aperture ratio to control the DOF to capture the first ROI 802 with sufficient sharpness. Large apertures (e.g., small f-stop numbers such as f/4.0) produce a very shallow DOF and small apertures (e.g., large f-stop numbers) produce images with a large DOF.

As a result of the large aperture ratio, the DOF is limited and a second ROI 804 in the image is located outside of the DOF, which results in the person in the second ROI 804 being blurred and not sufficiently sharp. In some aspects, the ROI analyzer 412 can control the image sensor 402 to shift the focus of a lens module (not shown) to improve the sharpness of the at least one ROI. For example, if there are four ROIs in the image and a background ROI is out of focus based on being outside of the DOF, the ROI analyzer 412 can be configured to modify the lens focus to shift the focal point to an intermediate point between the background ROI and the four ROIs to ensure that each ROI has a sharpness that can be corrected using iterative techniques, one or more machine learning models, and/or other techniques.

FIG. 9 illustrates an example of a trigger module 900 that is configured to enable or disable a SR function in accordance with some aspects of the disclosure. In some aspects, the trigger module 900 can be used in various different devices. In one aspect, the trigger module can use a gaze detection module 902 to determine whether to activate a SR. For example, an image capturing system can be configured to enable the SR function based on a subject of the captured image. By way of example, a viewfinder function can identify the gaze of a person during a viewfinder function and can identify that the person is not focused as described above. As a result, the focal length of the image sensor can be modified to minimize loss of focus (e.g. minimize loss in sharpness) by shifting the focal length between a foreground target and a background target.

In other aspects, the trigger module 900 can include a speech detection module 904 that is configured to detect speech of a person that is within a captured image. In some aspects, the speech detection module can use speech detection that is detected by an auxiliary device (e.g., a smart speaker) to identify the speaker. For example, the speech can be used by a user device including the trigger module to authenticate that the speaker corresponds to an authenticated user of the user device, and then enable SR functions associated with people who are known by the user device. The user device can be informed of people who are known based on frequent usage of the user device to capture images, or make other inferences that correspond to a relation of the person within the captured images.

The trigger module 900 can also include a face identification module 906 to identification to enable SR functions. For example, in the event that a person is browsing their photographs with their user device, the user device can identify certain parameters that selectively enable the user device to perform SR functions in the captured images. In the event a person is identified in at least two previous images, the disclosed systems and techniques can then enable SR of that user without user input to enhance the image quality associated with an ROI in the image. In some aspects, the face identification module 906 can be related to and/or combined with a biometric function associated with the user device. For example, if an authenticated user of the user device is identified in a lock screen, the face identification module 906 can selectively authenticate the user of the user device for an image capture function using an internal application or an external third-party application.

Further aspects include a touch detection module 908 to enable SR functions based on touch input. By way of example, the user may purposefully or accidentally select a person in the user device to enable SR functions. The trigger module 900 may also include a brightness/occlusion module 910 that is configured to detect if the SR functions can be performed based on brightness and/or detection of occlusion due to varying lighting conditions. For example, some shading conditions can prevent the user device from correctly applying a deep learning model to improve the quality of an upsampled image. The brightness/occlusion module 910 can also be configured to detect an exposed face or other characteristics that are indicative of facial information and enable and/or disable SR functions based on the detected information. In further aspects, the trigger module 900 may also includes a device orientation module 912 that is configured to determine whether an orientation (e.g., yaw, pitch, and/or roll) indicates that an SR function is enabled or disabled. For example, if the user device is rotated at an angle that is not normal (e.g., not representative), the user device can determine that there are no faces in the captured image and determine that an input was inadvertently received and the SR function should be disabled.

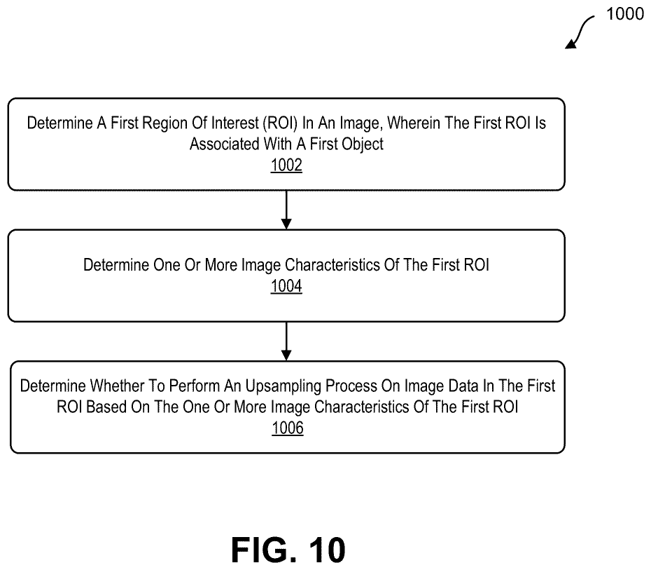

FIG. 10 is a flowchart illustrating an example of a method 1000 for processing image data, in accordance with certain aspects of the present disclosure. The method 1000 can be performed by a computing system or device (or component thereof, such as a chipset) device having an image sensor, such as a mobile wireless communication device, a camera, an XR device, a wireless-enabled vehicle, or another computing device. In one illustrative example, a computing system 1400 can be configured to perform all or part of the method 1000. In one illustrative example, an ISP such as the ISP 254 can be configured to perform all or part of the method.

At block 1002, the computing system (or component thereof) may be configured to determine a first region of interest (ROI) in an image, wherein the first ROI is associated with a first object. An example of a first object includes a person (e.g., the face of a person), but the first object could be any other object such as a landmark, an animal, vegetation, etc.

At block 1004, the computing system (or component thereof) may be configured to determine one or more image characteristics of the first ROI. In some aspects, the one or more image characteristics include at least one of a size of the first ROI or a distance of the first ROI from a focal point associated with the image.

In one illustrative aspect, the computing system (or component thereof) may determine the size of the first ROI is less than a size threshold (e.g., 100 pixels×100 pixels). The computing system may determine to perform the upsampling process on the image data in the ROI based on the size of the first ROI being less than the size threshold. In some aspects, the ROI may be associated with the ML model, such as an ML model that is trained to perform a super-resolution function based on downsampled images having a resolution of 100 pixels×100 pixels. For example, a GAN can receive original images (e.g., 400 pixels×400 pixels) and downsampled version of the original image (e.g., 100 pixels×100 pixels) and the GAN learns techniques to upsample the downsampled image to correspond to the original image.

In another illustrative aspect, the computing system (or component thereof) can be a component of an imaging system (e.g., a camera) that can use the ROIs to improve the image quality. According to this aspect, the computing system (or component thereof) or the imaging system may determine the distance of the first ROI from the focal point is greater than a threshold distance. The computing system (or component thereof) or the imaging system can determine to perform the upsampling process on the image data in the first ROI based on the distance of the first ROI from the focal point being greater than the threshold distance.

Another illustrative aspect is related to an object corresponding to an ROI being positioned outside a DOF and the ROI can be blurry. In this aspect, the computing system (or component thereof) or the imaging system may determine a second ROI in the image and the second ROI is associated with a second object. The computing system (or component thereof) or the imaging system may determine not to perform the upsampling process on image data in the second ROI based on the one or more image characteristics of the second ROI. For example, the size of the ROI can be larger than the threshold. In another example, the imaging system can determine that the sharpness of the image does not satisfy a threshold sharpness value. In some cases, the first ROI and the second ROI are associated with a common object type. For instance, the computing system (or component thereof) or the imaging system may determine the first ROI and the second ROI are associated with a common object type. In one aspect, the common object type may be a face region of a person. Other examples object types include a vehicle, a person, a landmark, a stationary object (e.g., a street sign), a bicycle, an animated object, vegetation, a geographic formation, an animal, and/or other objects.

At block 1006, the computing system (or component thereof) may be configured to determine whether to perform an upsampling process on image data in the first ROI based on the one or more image characteristics of the first ROI. In one illustrative aspect, the computing system is configured to use a ML model to perform a upsampling process or a super-resolution process (or function) on images having a resolution of 100 pixels×100 pixels as described above.

In some aspects, the computing system may be configured to align the ROI to improve the upsampling process when the computing system determines to perform the upsampling process. In one illustrative aspect, the computing system may detect keypoints associated with the first ROI and transform a portion of the image based on aligning the keypoints associated with the first ROI. For example, the first ROI can be the face of a person and the computing system can detect keypoints associated with the eyes, nose, and mouth and use the keypoints to align the first ROI. The alignment of the keypoints may improve the upsampling process. The computing system, based on transforming the portion of the image, may obtain an output image from a ML model trained to increase a resolution and enhance the face at least in part by inputting the first ROI.

The computing system (or components thereof) may be configured to superimpose the output image (e.g., from an ML model) on an upsampled version of the image. For example, the computing system may upsample the entire image and may superimpose the first ROI that has been upsampled by the ML model into the upsampled version of the image. In other aspects, the computing system can superimpose the first ROI that has been upsampled into the original image. In this case, when a user zooms in on the first ROI, the image quality of the first ROI in increased.

In some aspects, the computing system may be configured to determine that the ROI creates visual fidelity issues while superimposing the upsampled ROI into the original (or resized) image. In one illustrative aspect, the computing system may be configured to resize a bounding box associated with the first ROI and determine that the resized bounding box crops skin information based on a border region of the resized bounding box. By cropping skin information, the superimposing of the ROI creates noise and lowers the visual fidelity. In some aspects, based on determining the resized bounding box crops skin information, the computing system may modify the resized bounding box to include a region outside of the resized bound box that corresponds to the skin information.

In some other aspects, the computing system may be a component of an imaging system, and the computing system may be configured to adjust image capture settings to improve visual fidelity of captured image. In one aspect, the computing system can detect a second ROI in the image and determine a sharpness differential between the first ROI and the second ROI. For example, the computing system can determine that the second ROI is blurrier than the first ROI and may then adjust a focus of a lens of an image sensor to increase a sharpness of the first ROI and decrease a sharpness of the second ROI for an additional image.

The computing system may then obtain the additional image based on adjusting the focus of the lens. In this case, the computing system improves the image quality of the second ROI, and the upsampling process can be applied to the first ROI and the second ROI to enhance image quality associated with the objects.

As noted above, the processes or methods described herein (e.g., method 1000, and/or other process described herein) may be performed by a computing system (or device or apparatus). In one example, the method 1000 can be performed by a computing device (e.g., image capture and processing system 200 in FIG. 2) having a computing architecture of the computing system 1400 shown in FIG. 14.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the methods described herein, including the method 1000. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of methods described herein. In some examples, the computing device may include a display, a network interface configured to communicate and/or receive the data, any combination thereof, and/or other component(s). The network interface may be configured to communicate and/or receive IP-based data or other type of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The method 1000 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the methods.

The method 1000, and/or other method or process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

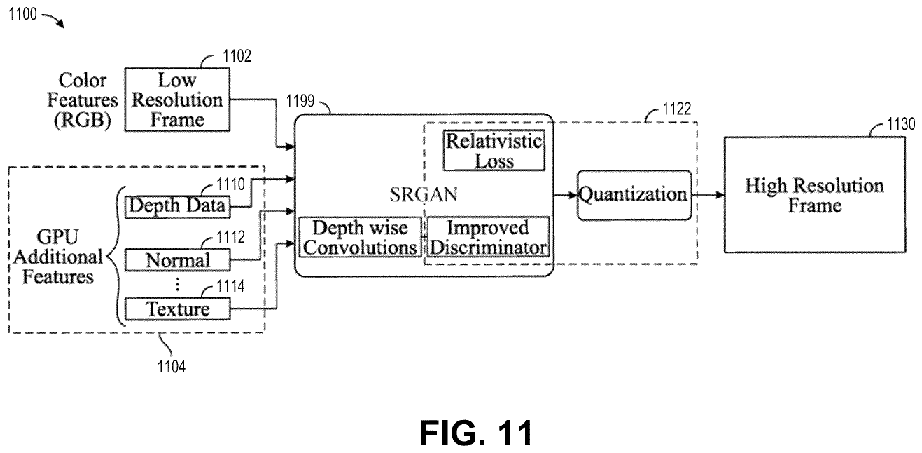

FIG. 11 illustrates an example diagram 1100 implementing super resolution of images that can be performed using a GAN, in accordance with certain aspects of the present disclosure. As shown, in certain embodiments, a neural network processor can be implemented as a GAN to generate content that is inferred based on training. The modified GAN takes the color features 1102, such as RGB values of the low resolution frame, and non-color features. As shown, the non-color features include one or more of depth information, normal information, or texture information. In some aspects, the GAN may perform a discriminator function that employs a relativistic loss function to identify a desired version of the high resolution output, learning the applicable parameters implemented by the neural network processor.

A quantization process 1122 is performed before outputting one or more high resolution frames 1130 (also referred to as a super-resolution frame or image). The quantization process 1122 evaluates effect of quantization. For example, the modified GAN quantizes the network using regular quantization methods available in standard framework. such as Tensorflow (or PyTorch) or vendor specific quantization methods (e.g., quantization offered by Qualcomm's SNPE SDK). In certain aspects, the quantization using the described methods for 8 bit/16 bit takes advantage of high-speed accelerators specially designed for 8 bit/16 bit operations to improve the performance with marginal quality compromise.

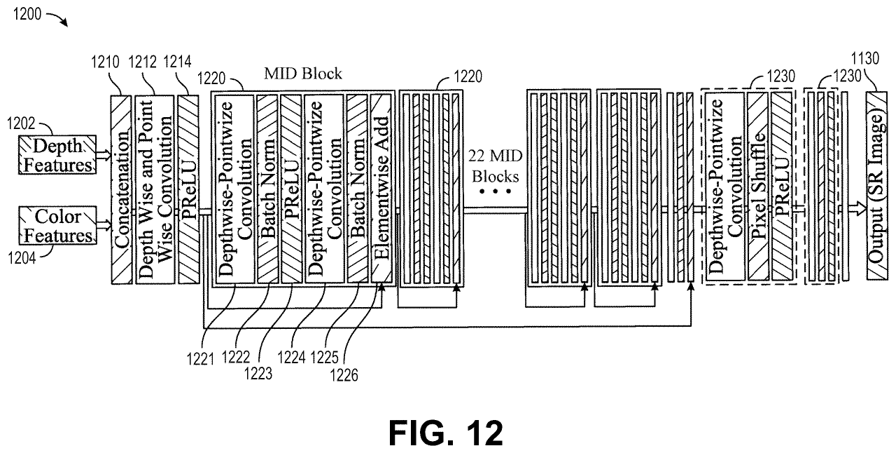

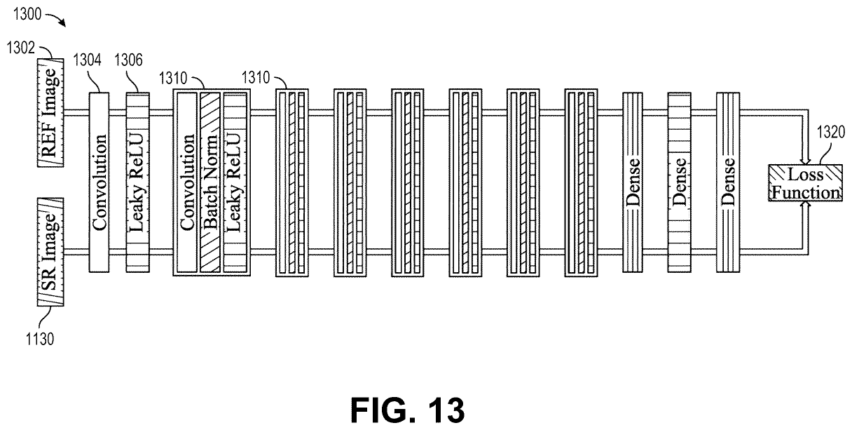

As shown, the GAN may accept additional various features, such as one or more of depth information, normal information, texture information, etc. The GAN also includes more learning parameters for a few more subsequent layers than known GAN examples, such as 22 subsequent layers instead of 10 layers of some GAN examples. This example is further illustrated in FIGS. 12 and 13.

In certain aspects, the number of mid-blocks (shown in FIGS. 12 and 13) used in the GAN are further tuned to balance between quality of output (e.g., the higher the quality, the greater computational demand, which may or may not be needed) and computational demand (e.g., gigaFLOPS). In certain aspects, this variant improves the performance and power budget of the computations.

FIG. 12 illustrates an example generator portion 1200 of the modified GAN of FIG. 11, in accordance with certain aspects of the present disclosure. As shown, the generator portion 1200 may receive depth features 1202 and the color features 1204 at the concatenation layer 1210. The concatenation layer 1210 is followed by the depth wise and point-wise convolution layer 1212. The convolution layer 1212 is followed by a parametric rectified linear unit (PReLU) layer 1214. The PReLu layer 1214 may learn parameters that control the shape and leaky-ness of the function.

A number of middle blocks (MID blocks) 1220 follow the PReLU layer 1214. As shown 22 MID blocks 1220 are included in the present example, but the total number of MID blocks may vary depending on output quality requirement. The exact number of feature maps (e.g., depth information, texture information, and normal information to be included at the concatenation layer 1210) as well as the MID blocks 1220 may be adjusted or tuned depending on the desired quality and performance. Each MID block 1220 includes a layer 1221 of depth-wise and point-wise convolution, a layer 1222 of batch norm, a PReLU layer 1223, another layer 1224 of depth-wise and point-wise convolution, another layer 1225 of batch norm, and a layer 1226 for element wise add.

After the series of MID blocks 1220, two or more blocks 1230 containing depth-wise and point-wise convolution, pixel shuffle, and PReLU follow. One or more depth-wise and point-wise convolution may follow before the high resolution frame(s) 1130 is/are output at the last layer. The outputted high resolution frame(s) 1130 may include two or more versions of predicted super resolution images of a low resolution input image.

FIG. 13 illustrates an example discriminator portion 1300 of the GAN in accordance with certain aspects of the present disclosure. The discriminator portion 1300 outputs fake or real information (to identify whether the material is generative or real) when comparing the super resolution images 1030 generated by the generator portion 1300 to a database of reference images. The real output may be (e.g., the most) accurate or realistic for final output by a neural network processor.

The discriminator portion 1300 may access reference images and receives the super resolution images 1030 from the generator portion 1300. modified GAN may use loss network (e.g., a VGG-19 network) generated features for comparison of predicted images and the reference images to learn corresponding parameters for a desired output. For example, the comparison is over the ReLU activated output of features. ReLU by nature suppresses all negative values and only positive values are considered. The GAN enhances the ReLU by removing the ReLU layer at the end of known GAN examples, and by letting full-scale features participate in the comparison.

The reference images and the super resolution images 1030 are inputted to the convolution layer 1304. A leaky ReLU layer 1306 follows the convolution layer 1304. The leaky ReLU layer 1306 may modify the ReLU function to allow small negative values when the input is less than zero. A series of MID blocks 1310 follow the leaky ReLU layer 1306. Each of the MID block 1310 includes a convolution layer, a batch norm layer, and a leaky ReLU layer. Similar to the MID blocks 1120, the number of MID blocks 1310 may vary depending on specific applications.

FIG. 14 is a diagram illustrating an example of a system for implementing certain aspects of the present technology. In particular, FIG. 14 illustrates an example of computing system 1400, which can be for example any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some aspects, computing system 1400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1400 includes at least one processing unit (CPU or processor) 1410 and connection 1405 that couples various system components including system memory 1415, such as ROM 1420 and RAM 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400. Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some aspects, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“ ”) and greater than or equal to (“ ”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method of processing one or more images, comprising: determining a ROI in an image, wherein the first ROI is associated with a first object; determining one or more image characteristics of the first ROI; and determining whether to perform an upsampling process on image data in the first ROI based on the one or more image characteristics of the first ROI.

Aspect 2. The method of Aspect 1, wherein the one or more image characteristics include at least one of a size of the first ROI or a distance of the first ROI from a focal point associated with the image.

Aspect 3. The method of Aspect 2, further comprising: determining the size of the first ROI is less than a size threshold; and determining to perform the upsampling process on the image data in the ROI based on the size of the first ROI being less than the size threshold.

Aspect 4. The method of any of Aspects 2 or 3, further comprising: determining the distance of the first ROI from the focal point is greater than a threshold distance; and determining to perform the upsampling process on the image data in the first ROI based on the distance of the first ROI from the focal point being greater than the threshold distance.

Aspect 5. The method of any of Aspects 1 to 4, further comprising: determining a second ROI in the image, wherein the second ROI is associated with a second object; determining one or more image characteristics of the second ROI; determining not to perform the upsampling process on image data in the second ROI based on the one or more image characteristics of the second ROI.

Aspect 6. The method of Aspect 5, wherein the first ROI and the second ROI are associated with a common object type.

Aspect 7. The method of Aspect 5, wherein the common object type comprises a face region of a person.

Aspect 8. The method of any of Aspects 1 to 7, further comprising: detecting keypoints associated with the first ROI, wherein the first ROI comprises a face of a person; and transforming a portion of the image based on aligning the keypoints associated with the first ROI.

Aspect 9. The method of Aspect 7, further comprising, based on transforming the portion of the image, obtaining an output image from a ML model trained to increase a resolution and enhance the face at least in part by inputting the first ROI.

Aspect 10. The method of Aspect 9, further comprising: superimposing the output image on an upsampled version of the image.

Aspect 11. The method of any of Aspects 1 to 10, further comprising: detecting a second ROI in the image; determining a sharpness differential between the first ROI and the second ROI; adjusting a focus of a lens of an image sensor to increase a sharpness of the first ROI and decrease a sharpness of the second ROI for an additional image; obtaining the additional image based on adjusting the focus of the lens.

Aspect 12. The method of any of Aspects 1 to 11, further comprising: resizing a bounding box associated with the first ROI; and determining that the resized bounding box crops skin information based on a border region of the resized bounding box; and modifying the resized bounding box to include a region outside of the resized bound box that corresponds to the skin information.

Aspect 13. An apparatus including at least one memory and at least one processor coupled to the at least one memory and configured to: determine a first ROI in an image, wherein the first ROI is associated with a first object; determine one or more image characteristics of the first ROI; and determine whether to perform an upsampling process on image data in the first ROI based on the one or more image characteristics of the first ROI.

Aspect 14. The apparatus of Aspect 13, wherein the one or more image characteristics include at least one of a size of the first ROI or a distance of the first ROI from a focal point associated with the image.

Aspect 15. The apparatus of Aspect 14, wherein the at least one processor is configured to: determine the size of the first ROI is less than a size threshold; and determine to perform the upsampling process on the image data in the ROI based on the size of the first ROI being less than the size threshold.

Aspect 15. The apparatus of any of Aspects 14 or 15, wherein the at least one processor is configured to: determine the distance of the first ROI from the focal point is greater than a threshold distance; and determine to perform the upsampling process on the image data in the first ROI based on the distance of the first ROI from the focal point being greater than the threshold distance.

Aspect 17. The apparatus of any of Aspects 13 to 16, wherein the at least one processor is configured to: determine a second ROI in the image, wherein the second ROI is associated with a second object; determine one or more image characteristics of the second ROI; and determine not to perform the upsampling process on image data in the second ROI based on the one or more image characteristics of the second ROI.

Aspect 18. The apparatus of Aspect 17, wherein the first ROI and the second ROI are associated with a common object type.

Aspect 19. The apparatus of Aspect 28, wherein the common object type comprises a face region of a person.

Aspect 20. The apparatus of any of Aspects 13 to 19, wherein the at least one processor is configured to: detect keypoints associated with the first ROI, wherein the first ROI comprises a face of a person; and transform a portion of the image based on aligning the keypoints associated with the first ROI.

Aspect 21. The apparatus of Aspect 20, wherein the at least one processor is configured to: based on transforming the portion of the image, obtain an output image from a ML model trained to increase a resolution and enhance the face at least in part by inputting the first ROI.

Aspect 22. The apparatus of Aspect 21, wherein the at least one processor is configured to: superimpose the output image on an upsampled version of the image.

Aspect 23. The apparatus of any of Aspects 13 to 22, wherein the at least one processor is configured to: detect a second ROI in the image; determine a sharpness differential between the first ROI and the second ROI; adjust a focus of a lens of an image sensor to increase a sharpness of the first ROI and decrease a sharpness of the second ROI for an additional image; and obtain the additional image based on adjusting the focus of the lens.

Aspect 24. The apparatus of any of Aspects 13 to 23, wherein the at least one processor is configured to: resize a bounding box associated with the first ROI; determining that the resized bounding box crops skin information based on a border region of the resized bounding box; and modify the resized bounding box to include a region outside of the resized bound box that corresponds to the skin information.

Aspect 25. A non-transitory computer-readable medium comprising instructions which, when executed by one or more processors, cause the one or more processors to perform operations according to any of Aspects 1 to 12.

Aspect 26. An apparatus comprising means for performing operations according to any of Aspects 1 to 12.

What is claimed is:

1. A method of processing one or more images, comprising:
determining a first region of interest (ROI) in an image, wherein the first ROI is associated with a first object;
determining one or more image characteristics of the first ROI; and
determining to perform an upsampling process on image data in the first ROI based on the one or more image characteristics of the first ROI.

2. The method of claim 1, wherein the one or more image characteristics include at least one of a size of the first ROI or a distance of the first ROI from a focal point associated with the image.

3. The method of claim 2, further comprising:
determining the size of the first ROI is less than a size threshold; and
determining to perform the upsampling process on the image data in the ROI based on the size of the first ROI being less than the size threshold.

4. The method of claim 2, further comprising:
determining the distance of the first ROI from the focal point is greater than a threshold distance; and
determining to perform the upsampling process on the image data in the first ROI based on the distance of the first ROI from the focal point being greater than the threshold distance.

5. The method of claim 1, further comprising:
determining a second ROI in the image, wherein the second ROI is associated with a second object;
determining one or more image characteristics of the second ROI; and
determining not to perform the upsampling process on image data in the second ROI based on the one or more image characteristics of the second ROI.

6. The method of claim 5, wherein the first ROI and the second ROI are associated with a common object type.

7. The method of claim 6, wherein the common object type comprises a face region of a person.

8. The method of claim 1, further comprising:
detecting keypoints associated with the first ROI, wherein the first ROI comprises a face of a person; and
transforming a portion of the image based on aligning the keypoints associated with the first ROI.

9. The method of claim 8, further comprising:
based on transforming the portion of the image, obtaining an output image from a machine learning (ML) model trained to increase a resolution and enhance the face at least in part by inputting the first ROI.

10. The method of claim 9, further comprising:
superimposing the output image on an upsampled version of the image.

11. The method of claim 1, further comprising:
detecting a second ROI in the image;
determining a sharpness differential between the first ROI and the second ROI;
adjusting a focus of a lens of an image sensor to increase a sharpness of the first ROI and decrease a sharpness of the second ROI for an additional image; and
obtaining the additional image based on adjusting the focus of the lens.

12. The method of claim 1, further comprising:
resizing a bounding box associated with the first ROI;
determining that the resized bounding box crops skin information based on a border region of the resized bounding box; and
modifying the resized bounding box to include a region outside of the resized bound box that corresponds to the skin information.

13. An apparatus for processing one or more images, comprising:
at least one memory; and
at least one processor coupled with the at least one memory and configured to:
determine a first region of interest (ROI) in an image, wherein the first ROI is associated with a first object;
determine one or more image characteristics of the first ROI; and
determine whether to perform an upsampling process on image data in the first ROI based on the one or more image characteristics of the first ROI.

14. The apparatus of claim 13, wherein the one or more image characteristics include at least one of a size of the first ROI or a distance of the first ROI from a focal point associated with the image.

15. The apparatus of claim 14, wherein the at least one processor is configured to:
determine the size of the first ROI is less than a size threshold; and
determine to perform the upsampling process on the image data in the ROI based on the size of the first ROI being less than the size threshold.

16. The apparatus of claim 14, wherein the at least one processor is configured to:
determine the distance of the first ROI from the focal point is greater than a threshold distance; and
determine to perform the upsampling process on the image data in the first ROI based on the distance of the first ROI from the focal point being greater than the threshold distance.

17. The apparatus of claim 13, wherein the at least one processor is configured to:
determine a second ROI in the image, wherein the second ROI is associated with a second object;
determine one or more image characteristics of the second ROI; and
determine not to perform the upsampling process on image data in the second ROI based on the one or more image characteristics of the second ROI.

18. The apparatus of claim 17, wherein the first ROI and the second ROI are associated with a common object type.

19. The apparatus of claim 18, wherein the common object type comprises a face region of a person.

20. The apparatus of claim 13, wherein the at least one processor is configured to:
detect keypoints associated with the first ROI, wherein the first ROI comprises a face of a person; and
transform a portion of the image based on aligning the keypoints associated with the first ROI.

21. The apparatus of claim 20, wherein the at least one processor is configured to:
based on transforming the portion of the image, obtain an output image from a machine learning (ML) model trained to increase a resolution and enhance the face at least in part by inputting the first ROI.

22. The apparatus of claim 21, wherein the at least one processor is configured to:
superimpose the output image on an upsampled version of the image.

23. The apparatus of claim 13, wherein the at least one processor is configured to:
detect a second ROI in the image;
determine a sharpness differential between the first ROI and the second ROI;
adjust a focus of a lens of an image sensor to increase a sharpness of the first ROI and decrease a sharpness of the second ROI for an additional image; and
obtain the additional image based on adjusting the focus of the lens.

24. The apparatus of claim 13, wherein the at least one processor is configured to:
resize a bounding box associated with the first ROI;
determine that the resized bounding box crops skin information based on a border region of the resized bounding box; and
modify the resized bounding box to include a region outside of the resized bound box that corresponds to the skin information.

25. A non-transitory computer-readable medium having stored thereon instructions that, when executed by at least one processor, cause the at least one processor to:
determine a first region of interest (ROI) in an image, wherein the first ROI is associated with a first object;
determine one or more image characteristics of the first ROI; and
determine whether to perform an upsampling process on image data in the first ROI based on the one or more image characteristics of the first ROI.

26. The non-transitory computer-readable medium of claim 25, wherein the one or more image characteristics include at least one of a size of the first ROI or a distance of the first ROI from a focal point associated with the image.

27. The non-transitory computer-readable medium of claim 26, wherein the instructions that, when executed by the at least one processor, cause the at least one processor to:
determine the size of the first ROI is less than a size threshold; and
determine to perform the upsampling process on the image data in the ROI based on the size of the first ROI being less than the size threshold.

28. The non-transitory computer-readable medium of claim 26, wherein the instructions that, when executed by the at least one processor, cause the at least one processor to:
determine the distance of the first ROI from the focal point is greater than a threshold distance; and
determine to perform the upsampling process on the image data in the first ROI based on the distance of the first ROI from the focal point being greater than the threshold distance.

29. The non-transitory computer-readable medium of claim 25, wherein the instructions that, when executed by the at least one processor, cause the at least one processor to:
determine a second ROI in the image, wherein the second ROI is associated with a second object;
determine one or more image characteristics of the second ROI; and
determine not to perform the upsampling process on image data in the second ROI based on the one or more image characteristics of the second ROI.

30. The non-transitory computer-readable medium of claim 25, wherein the instructions that, when executed by the at least one processor, cause the at least one processor to:
detect keypoints associated with the first ROI, wherein the first ROI comprises a face of a person; and
transform a portion of the image based on aligning the keypoints associated with the first ROI.
